(19) United States
(12) Patent Application Publication
(10) Pub. No.: US 2008/0183501 A1
(43) Pub. Date: Jul. 31, 2008

(54) System and Method for Automated Categorization of Reference Exams

(75) Inventors: Christopher Beaulieu, Los Altos, CA (US); Raghav Raman, Cupertino, CA (US); Prakash Mahesh, Hoffman Estates, IL (US); Vijaykalyan Yeluri, Sunnyvale, CA (US); Denny Lau, Redwood City, CA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/669,659

(22) Filed: Jan. 31, 2007

(51) Int. Cl. G06Q 50/00

(52) U.S. Cl. 705/3

(57) ABSTRACT

An automated system and method for updating reference materials in a healthcare setting. The automated system may comprise a collection of medical reference materials connected to a network, an exam database connected to the network, and a workstation connected to the network for evaluating data stored in the exam database. The method may comprise the steps of tagging exam data, processing the exam data to extract categorizing information, categorizing the exam data, and storing the exam data in a reference collection.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Embodiments of the present method and system relate generally to electronic data collection and display in a healthcare setting. Particularly, certain embodiments relate to providing automated methods and systems for updating medical reference materials.

Many traditional medical textbooks have been converted to electronic formats, particularly in the field of radiology. Users of such electronic textbooks use computers to navigate the textbook contents. One advantage that these electronic textbooks offer over conventional texts is the ability for users to link to large databases of images or other data that can enhance the learning experience. However, the reference materials linked to electronic texts tend to contain static content. That is, there is typically no mechanism for users of the electronic texts or educators using such texts to add content to the databases. In the medical profession, a tremendous amount of learning is empirical or based on actual cases and the lessons gathered from the diagnosis and treatment of specific physiological conditions. Thus, there is a need for electronic texts to have their reference collections updated to reflect the empirical learning common to the medical profession.

Moreover, collections of reference exams are useful not only for the education of new clinicians and the continuing education of existing clinicians, but also for decision support in the clinic. Clinical decision support refers to using a knowledge base and a mechanism for drawing inferences based on a set of expert rules in order to guide diagnosis.

As with traditional texts, both the main body of the electronic text and any linked reference material are categorized by anatomy, pathology, or some other relevant indexing system. Thus, there exists a classification system inherent in the electronic texts that may allow for integration of new data into the main body or reference materials of an electronic text. There is a need for a convenient way to take advantage of this inherent classification system to update reference materials using clinically relevant data.

As clinics, hospitals, and other healthcare facilities have come to rely more and more on computers over the last several decades, much of the data useful for updating electronic texts exists in electronic formats. In particular, healthcare facilities employ certain types of digital diagnostic imaging modalities, such as computed tomography, magnetic resonance imaging, ultrasound imaging, and X-ray imaging. The images gathered on these systems are stored in electronic formats, as are the orders used to generate the images and the clinical reports that result from clinical analysis of the images.

Manipulation of these electronic data sets, such as clinical reports and clinical images is known. One method used for manipulating large clinical data sets is natural language processing. Natural language processing converts computer-readable text, typically in a narrative format, into an often predefined, structured form. This structured form can be used for further analysis of the data. For example, Hripcsak et al. used natural language processing to structure over 800,000 clinical reports and compare the findings in the reports. (G. Hripcsak, J. H. Austin, P. O. Alderson, C. Friedman, Use of natural language processing to translate clinical information from a database of 889,921 chest radiographic reports. Radiology. July 2002; 224(1):157-63). Other uses of natural language processing in a radiology setting include A. A. Bui, R. K. Taira, S. El-Saden, A. Dordoni, D. R. Aberle, Automated medical problem list generation: towards a patient timeline. Medinfo. 2004; 11(Pt 1):587-91 and K. J. Dreyer, M. K. Kalra, M. M. Maher, A. M. Hurier, B. A. Asfaw, T. Schultz, E. F. Halpern, J. H. Thrall, Application of recently developed computer algorithm for automatic classification of unstructured radiology reports: validation study. Radiology. February 2005; 234(2):323-9.

What is needed is a system and method for applying classification methods in real time to medical data. Such real time classification could take advantage of the common electronic formats of clinical data and reference materials to provide an automated way for updating medical reference collections.

### BRIEF SUMMARY OF THE INVENTION

Certain embodiments of the present invention include a method for automated collection of medical reference materials. Certain embodiments of the method comprise the steps of tagging exam data, processing the exam data to extract categorizing information, categorizing the exam data, and storing the exam data in a reference collection.

Certain embodiments of the present invention include an automated system for updating reference materials in a healthcare setting. Certain embodiments of the automated system comprise a collection of medical reference materials connected to a network, an exam database connected to the network, and a workstation connected to the network for evaluating data stored in the exam database. The collection of medical reference materials may have a set of reference exams. The data evaluation on the workstation may comprise tagging data for categorization.

### BRIEF DESCRIPTION OF SEVERAL VIEWS OF THE DRAWINGS

FIG. 1 illustrates a workflow diagram for a method for updating medical reference materials based on an automated characterization of exam data in accordance with an embodiment of the present invention.

FIG. 2 illustrates a networked system employing an automated method for collection and categorization of exam data for updating medical reference materials in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentalities shown in the attached drawings.

### DETAILED DESCRIPTION OF THE INVENTION

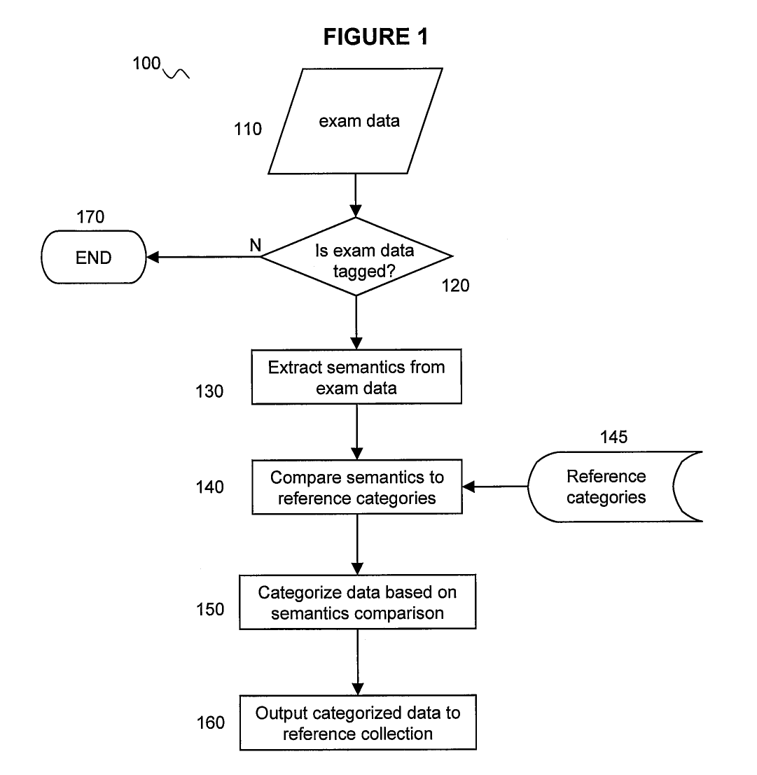

FIG. 1 illustrates a workflow diagram 100 for a method of updating medical reference materials based on an automated characterization of exam data in accordance with one embodiment of the present invention. The workflow diagram begins with exam data 110, which has been collected as a result of a clinical exam. Exam data 110 may include an exam order, which typically is a data set that contains information such as patient demographics and a description of the diagnostic and/or therapeutic procedure to be performed. The exam order may contain other information, such as patient history. Exam data 110 may contain an image or series of images that are generated as a result of the execution of the exam order. For example, exam data 110 may contain a C-T scan. Further, exam data 110 may contain an exam report. The exam report may contain a clinician's analysis, and/or diagnosis of a patient's condition based on interpretation of an image or series of images. According to one embodiment of the present invention, exam data 110 contains an exam order, an exam image or images, and an exam report.

Referring to FIG. 1, exam data 110 may also contain a tag. A tag may be a data field inside exam data 110 that contains a certain value, such as “1” if the tag is activated or “0” if the tag is not activated. Preferably, the default setting is that the tag is not activated. The tagging of the data takes place following a tagging routine according to one embodiment of the present invention. In that sense, a clinician may “activate” a tag, but the actual tagging is accomplished through the software or tagging routine. Such a tagging routine may be stored on a workstation used by a clinician or it may be stored elsewhere on a network to which the workstation is connected. According to one embodiment of the present invention, the tag activated by the clinician indicates the clinician's preference that exam data 110, or some part of exam data, be added to a medical reference collection. For example, during analysis of an exam image a clinician may note a unique aspect of the image. Such an aspect may illustrate well a specific condition or a diagnostic indicator of a condition and therefore be valuable as a teaching tool.

Still referring to FIG. 1, query 120 in workflow diagram 100 interrogates exam data 110 to determine whether a tag has been activated. In the event no tag has been activated and the query answer is “NO,” the automated characterization workflow ends as illustrated by termination point 170 in accordance with one embodiment of the present invention. Of course, reaching termination point 170 does not prevent exam data 110 from being part of other concurrent or subsequent workflows or from being shared or stored on other parts of a network on which the exam data resides.

In the event that a clinician activates a tag in exam data 110 and the query answer is “YES,” exam data 110 proceeds to extraction step 130 according to one embodiment of the present invention. Extraction step 130 parses exam data 110 and extracts information that matches a set of predefined rules or categories. Parsing exam data 110 may involve a natural language processing routine according to one embodiment of the present invention.

Natural language processing enables extraction step 130 to scan the text-based data of exam data 110 and parse out key semantics according to one embodiment of the present invention. Key semantics may include the clinical finding that identifies the pathology of interest in the exam. Each exam procedure may then be associated with a preset list of pathologies that may be used as attributes to describe the exam. The natural language processing of the report could determine whether each pathology attribute is true (present) or false (not present). Such a detailed list of attributes would allow for much more specific image retrievals. Thus, extracting step 130 is useful for a method of automated collection and categorization of exam data 110 for updating medical reference materials in that extraction step 130 extracts key information for categorizing exam data 110, according to one embodiment of the present invention.

According to one embodiment of the present invention, extracting step 130 may extract data from an image or series of images. In such a case where the data is extracted from an image, extracting step 130 preferably examines the data fields associated with the image, such as the Digital Imaging and Communications in Medicine (DICOM) information commonly used with radiology images. The DICOM vocabulary is typically more limited that the narrative vocabulary used in a clinical report. Thus, a natural language processing routine may not be needed to extract data from the DICOM data fields associated with an image. The limited vocabulary of the DICOM fields may be parsed to extract DICOM terms commonly known to overlap with reference categories in medical reference collections. Similarly, exam orders may be parsed for HL-7 protocol terms, for example, as exam orders typically are formatted in the HL-7 protocol.

Referring to FIG. 1, comparison step 140 compares the extracted semantics from extracting step 130 with a set of reference categories 145 according to one embodiment of the present invention. Reference categories 145 may be a pre-existing set of terms that relate to the categories of a reference collection. For example, if the reference collection is related to an electronic radiology text, then reference categories 145 may include terms based on the American Board of Radiology categories of teaching files, shown below in Table 1:

TABLE 1
American Board of Radiology Categories of Teaching Files

Musculoskeletal
Pulmonary
Cardiovascular
Gastrointestinal
Genitourinary
Neuro
Vascular and Interventional
Nuclear
Ultrasound
Pediatric
Breast

An alternative way of categorizing extracted data would be to associate a set of attributes gathered from the findings in an exam report that would be relevant to a type of exam (e.g. the MR Brain example above). Each type of exam will have a unique set of possible associated findings (e.g. a C-T scan of the chest will have a different set of findings than a MR scan of the brain).

In one embodiment of the method of the present invention, extraction step 130 provides semantics to comparison step 140 in a specific grammatical form for comparison with reference categories 145. For example, extraction step 130 may provide the noun “fiber” to comparison step 140 in the event the term “fibrous” was identified in exam data 110 during extraction step 130. Or, extraction step 130 may provide multiple grammatical formats for a given term, such as “fiber,” “fibers,” “fibril,” “fibrils,” “fibrous” and “fibrillar.” Multiple grammatical formats serve at least the purpose of providing multiple points of comparison to reference categories 145. That is, reference categories 145 may have grammatical formats different than the specific grammatical format of the semantics being extracted in extraction step 130.

Further, reference categories 145 may span a number of individual medical references in a collection, according to one embodiment of the present invention. For example, reference categories 145 may include categorizing terms from an electronic radiology text, an electronic oncology text, and an electronic physiology text. In such an example, a given categorizing term may have slight variations from one text to another. Thus, providing multiple grammatical formats for extracted semantics may facilitate categorization in multiple references.

In one embodiment of the present invention, comparison step 140 may perform grammatical formatting to facilitate categorization. Or, both extraction step 130 and comparison step 140 may perform grammatical formatting to facilitate categorization. In any event, comparison step 140 performs the function of filtering through the extracted semantics to provide a list of semantics that overlap with reference categories 145 according to one embodiment of the present invention. Comparison step 140 may provide a list of multiple overlaps within a single reference collection or across multiple collections.

Referring again to FIG. 1, the comparison performed by comparison step 140 is useful at least for use in categorizing step 150. According to one embodiment of the present invention, categorizing step 150 examines the extracted semantics found to overlap with reference categories 145. Categorizing step 150 may determine the specific source of the extracted semantics, such as whether the semantics were extracted from an exam order, an exam image, an exam report, or another source of exam data 110. In determining the source of extracted semantics, categorizing step 150 may provide links or other metadata useful for linking to or storing exam data 110 according to one embodiment of the present invention. Such links or other metadata may facilitate the collection of exam data 110. For example, if the source of the overlapping extracted semantics is an exam report, categorizing step 150 may identify the data archive on which the exam report is stored through metadata associated with the exam report. Identifying the storage location of the exam report allows for correct linking or copying of the exam report into the appropriate reference collection.

Referring to FIG. 1, output step 160 links the categorized data to the appropriate reference collection according to one embodiment of the present invention. Linking the categorized data to the reference collection may be preferable when the sources of the categorized data and the reference collection are available on the same network. Linking the data to the reference collection may avoid unnecessary duplication of data and preserve storage space. Alternately, output step 160 stores the categorized data with the other reference data in the appropriate reference collection. Preferably, the linking or storage of the categorized data does not interfere with further retrieval or other access to the source of the exam data in the event the data is needed for diagnosis or other clinical purposes.

According to one embodiment of the present invention, output step 160 may remove certain patient demographic information from the categorized data in order to preserve patient confidentiality. Since the data may be linked to a reference collection for educational purposes, certain patient demographic data, such as age and gender, may be useful for furthering the educational purpose of the reference collection. However, other patient demographic information that may be part of exam data 110 is potentially unnecessary for educational purposes, such as, for example, the patient's name or Social Security number.

The technical effects of certain embodiments of the present method are tagging exam data, processing the exam data to extract categorizing information, categorizing the exam data, and storing the exam data in a reference collection.

The steps described above are illustrated in FIG. 1 as occurring sequentially. However, in certain embodiments of the present invention, some or all of the steps described above may occur in parallel. Further, some of the steps described above may be collapsed into a single step according to certain embodiments of the present invention. Of course, modifications in the timing, order, or number of steps of the method of the present invention are contemplated and are within the scope of certain embodiments of the method. Further, the steps of the method may be carried out repeatedly in a loop according to certain embodiments of the present invention.

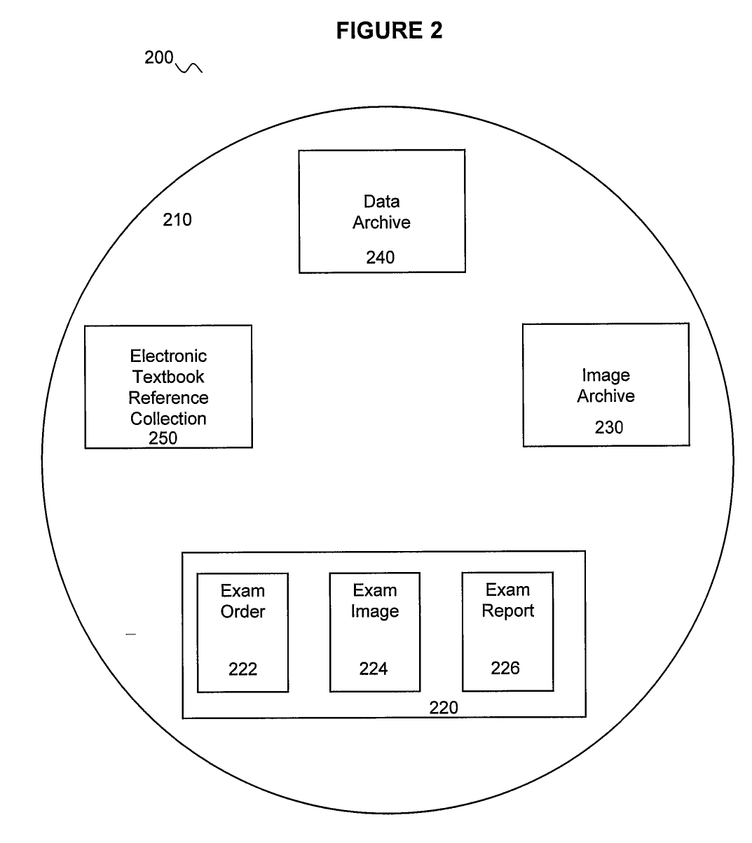

FIG. 2 illustrates networked system 200 employing an automated method for collection and categorization of exam data for updating medical reference materials in accordance with an embodiment of the present invention. Network environment 210 provides the backbone for system 200. Workstation 220, image archive 230, data archive 240 and reference collection 250 are connected to network 210 and therefore interconnected with each other.

According to one embodiment of the present invention, workstation 220 provides a user interface that enables a clinician to interact with exam data such as exam order 222, exam image 224 and exam report 226. A clinician may create and/or edit exam order 222 and exam report 226 using workstation 220 and may view and edit exam image 224 using workstation 220. Workstation 220 is connected to image archive 230 and data archive 240 to facilitate access to stored data as well as storage of created or edited data.

In addition to viewing and manipulating exam data on workstation 220, a clinician may activate a tag on exam data using workstation 220 according to one embodiment of the present invention. A clinician may activate a tag to identify exam data for automated characterization for addition to a reference collection. In the event a tag is activated, exam order 222, exam image 224, and exam report 226 may all be processed for categorization and storage in a reference collection.

Exam image 224 may be stored in image archive 230, according to one embodiment of the invention. If exam image 224 has been added to a reference collection according to one method of the present invention, then exam image 224 may also be stored in reference collection 250. Alternately, reference collection 250 may contain a link to exam image 224. In such a case where reference collection 250 contains a link to exam image 224, if a user of reference collection 250 would like to view exam image 224, then reference collection 250 can cause exam image 224 to be retrieved from image archive 230.

Similarly, exam report 226 and exam order 222 may be stored in data archive 240, according to one embodiment of the invention. If exam report 226 and/or exam order 222 has been added to a reference collection according to one method of the present invention, then exam report 226 and/or exam order 222 may also be stored in reference collection 250. Reference collection 250 may contain a link to exam report 226 and/or exam order 222.

Referring to FIG. 2, as noted above workstation 220, image archive 230, data archive 240 and reference collection 250 are connected to network 210 and therefore interconnected with each other. In addition to being able to tag exam data for processing and addition to reference collection 250, a clinician may retrieve reference data from reference collection 250 via workstation 220 according to one embodiment of the present invention. Thus, workstation 220 provides a clinician the ability to both update reference collection 250 and to retrieve references from reference collection 250.

### EXAMPLE

In one example of an embodiment of the present invention, a radiologist uses a PACS workstation to retrieve a series of images related to a magnetic resonance (MR) scan of a patient's brain. Upon examining the image series, the radiologist records the following notes in the findings section of a clinical report: “Increased T2 and FLAIR signal in the periventricular white matter and central pons, consistent with chronic small vessel ischemic change. No hemorrhage, no mass, no midline shift, no hydrocephalus, no signal abnormality on diffusion weighted images, no brain parenchymal signal abnormality on conventional images, no abnormal extra axial fluid collection, no bone lesion, paranasal sinuses are clear.” The radiologist decides that this series of images is a particularly clear example of a certain pathology and tags the image by marking a field in the display of PACS workstation. Now that the image is marked, it is processed using natural language processing to yield the following text string: “chronic small vessel ischemic change.” The images and the report are then linked to the Neurovascular category of an appropriate radiology text and a neurology text.

Embodiments of the present invention provide systems and methods for automated categorization of clinical data for addition of such data to medical reference collections. Certain embodiments take advantage of common electronic formats of clinical data and medical reference materials to provide a system and method for updating the medical reference materials. Certain embodiments take advantage of developments in data processing, such as for example natural language processing, to provide a real-time classification system and method.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for automated collection of medical reference materials comprising the steps of:
tagging exam data;
processing the exam data to extract categorizing information;
categorizing the exam data; and
storing the exam data in a reference collection.

2. The method of claim 1 wherein the tagging is initiated by a user of a Picture Imaging and Archiving System (PACS) workstation.

3. The method of claim 1 wherein at least part of the exam data is selected from the group consisting of a radiology report, a radiology order, or a radiology image.

4. The method of claim 3 wherein the radiology report, radiology order, or radiology image contains data in a Unified Medial Language System format.

5. The method of claim 3 wherein the radiology report, radiology order, or radiology image contains data in a DICOM format.

6. The method of claim 1 wherein the processing step comprises natural language processing.

7. The method of claim 1 wherein the categorizing step compares categorizing information extracted in the processing step to categories in the reference collection.

8. The method of claim 1 wherein the reference collection is part of an electronic medical textbook.

9. The method of claim 8 wherein the electronic medical textbook is a radiology textbook.

10. An automated system for updating reference materials in a healthcare setting comprising:
a collection of medical reference materials connected to a network, the collection having a set of reference exams;
an exam database connected to the network; and
a workstation for evaluating data stored in the exam database, wherein the data evaluation comprises tagging data for categorization and the workstation is connected to the network.

11. The system of claim 10 wherein the network comprises a categorizing engine.

12. The system of claim 11 wherein the categorizing engine comprises a natural language processor.

13. The system of claim 10 wherein the set of reference exams is automatically updated with categorized data.

14. The system of claim 10 wherein the exam database comprises an image archive.

15. The system of claim 10 wherein the exam database comprises a Radiology Information System (RIS).

16. The system of claim 10 wherein the workstation is a PACS workstation.

17. The system of claim 10 wherein the collection of medical reference materials comprises at least one electronic medical textbook.

18. The system of claim 10 wherein the collection of medical reference materials comprises an electronic radiology textbook.

19. A computer readable storage medium including a set of instructions for a computer, the set of instructions comprising:
a tagging routine for selecting exam data;
a processing routine for extracting category information from the exam data;
a categorizing routine; and
a storing routine for adding the categorized exam data to a collection of reference data.

20. The computer readable medium of claim 19, wherein the processing routine comprises a natural language processing routine.
